(19) United States
(12) Patent Application Publication
(10) Pub. No.: US 2003/0122471 A1
(43) Pub. Date: Jul. 3, 2003

(54) Use of multiple circuit elements for back side connection to a flat panel display

(76) Inventors: Robert C. Sundahl, Phoenix, AZ (US); Lawrence A. Booth JR., Phoenix, AZ (US)

Correspondence Address: MARGER JOHNSON & McCOLLOM, P.C., 1030 SW Morrison Street, Portland, OR, 97205, US

(21) Appl. No.: 10/038,501

(22) Filed: Jan. 3, 2002

(51) Int. Cl. H01J 9/00; H01J 19/62; H01J 31/20

(52) U.S. Cl. 313/422; 445/24

(57) ABSTRACT

A display panel is structured for attachment of multiple circuits using a two-dimensional array of contacts. Components, constituting driver circuits, can be mounted to the back of the panel in a central region of the panel rather than at the edges thereof.

### BACKGROUND OF THE INVENTION

The present disclosure relates to the field of interconnections to flat panel displays, and more specifically to a display panel structured for attachment of multiple circuits using a two-dimensional array of contacts.

A conventional display panel includes a plurality of display cells operative to render an image. Provided for the display cells are display contacts configured to receive a driver circuit to drive the display cells. The driver circuits are generally mounted on the edge of the display panel. Presently, interconnections between a flat panel display and other electronic components, such as driver circuits, are made in several ways.

Multiple contacts on a panel edge can be attached to an interconnection element, such as a flex circuit. These elements then provide interconnection to separate circuit boards. Alternatively, an integrated circuit can be bonded directly to an edge of the flat panel display. Lastly, thin film transistors can be fabricated directly on the display glass and used to provide driver and function controls.

These approaches require additional area around the display edge. Because a plurality of drivers are located in the peripheral region of the display panel in an edge connection arrangement, fabrication and processing steps are costlier than conventional processes. Panels using thin film transistors also have greater fabrication costs compared to conventional display panels.

The above-described edge connection scheme can further contribute to increased line resistance or capacitance, which may adversely affect the performance of the display. Additionally, the edge connection approach may require an undesirably high voltage level to drive the pixels. In some cases, the edge connections can require a significant mounting area in the peripheral region of the display, thereby limiting the area available for the display itself and increasing cost, manufacturing difficulty, and panel durability.

One solution to the above problems has been to form larger flat panel displays from smaller display units by tiling the smaller display units. Individual display units or tiles are usually arranged in an array and attached to each other along the edges of the display tiles, thereby forming a single tiled flat panel display of larger size.

These approaches are limited by the use of a single circuit board back panel to effect interconnection to the display front panel. As the size of the display increases or the pitch of the array contacts decreases, increasing demand is placed on the flatness requirements for the panels.

A further disadvantage of tiling is that routing of contacts between the display cells and the driver circuits are constrained by the edge connections. Moreover, seams between the adjacent display tiles must be concealed so that the final assembled flat-panel display can be viewed as a seamless single display unit. One approach to solve this problem is employment of a black matrix on an optical integration plate that aligns with the individual pixels on the display tiles. While this approach is successful, it increases production costs and imposes limitations on display size and shape.

### BRIEF DESCRIPTION OF THE DRAWINGS

FIG. 1 is a front view diagram of a prior art display panel with a plurality of contacts distributed around the edge of the panel.

FIG. 2 is a front view diagram of a panel constructed according to the present disclosure.

FIG. 3 is an enlarged front view diagram of a portion of the panel of FIG. 2.

FIG. 4 is a partial cross-sectional diagram of the panel of FIG. 2.

FIG. 5 is a perspective diagram of the panel of FIG. 2 having a driver circuit board attached thereto.

FIG. 6 is a view of the panel similar to FIG. 5 with multiple driver circuit boards mounted thereon.

FIG. 7 is a view of the panel similar to FIG. 5 with a plurality of driver circuit boards mounted in the central region of the panel.

### DETAILED DESCRIPTION OF EMBODIMENTS

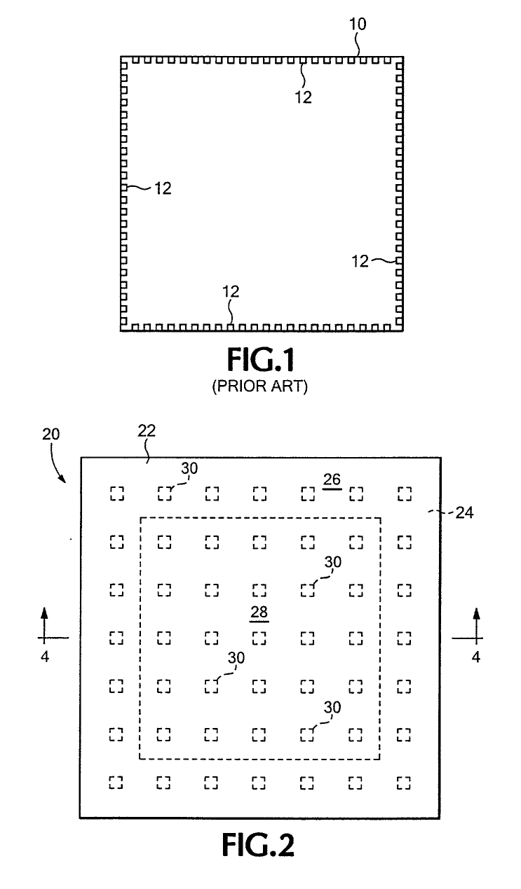

FIG. 1 shows a prior art panel 10 having contacts 12 for driver circuits. The contacts 12 are conventionally distributed about the edge of the panel.

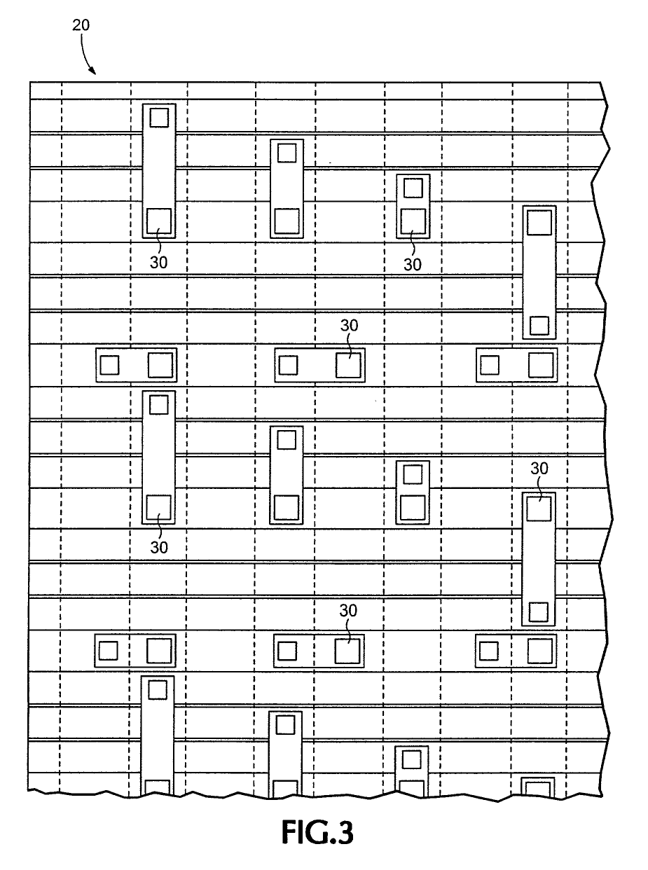

An exemplary embodiment of a display panel as disclosed herein is illustrated in FIGS. 2-4. The panel 20 has a front side 22 and a back side 24 and further includes a peripheral region 26 and a central region 28.

A pattern of contacts 30 is distributed on the back side 24 of the panel 20. The pattern is disposed in the central region 28 as well as the peripheral region 26. The pattern of contacts constitutes a matrix of interconnection points. The contacts can be bond pads or other structure suitable for forming an interconnect between the panel and a component.

The pattern of contacts is selectively placed to connect a component, (e.g., a circuit board, an integrated circuit, or other passive or active component) to the display contacts 22 in the panel. For illustrative purposes, the pattern is shown as a regular two-dimensional array of contacts. It should be readily apparent that the pattern of contacts need not be regularly and uniformly arrayed, but can be disposed on the back side of the panel in numerous alternative arrangements. Such aid arrangements are motivated by considerations, e.g., driver circuit placement and display device dimensions.

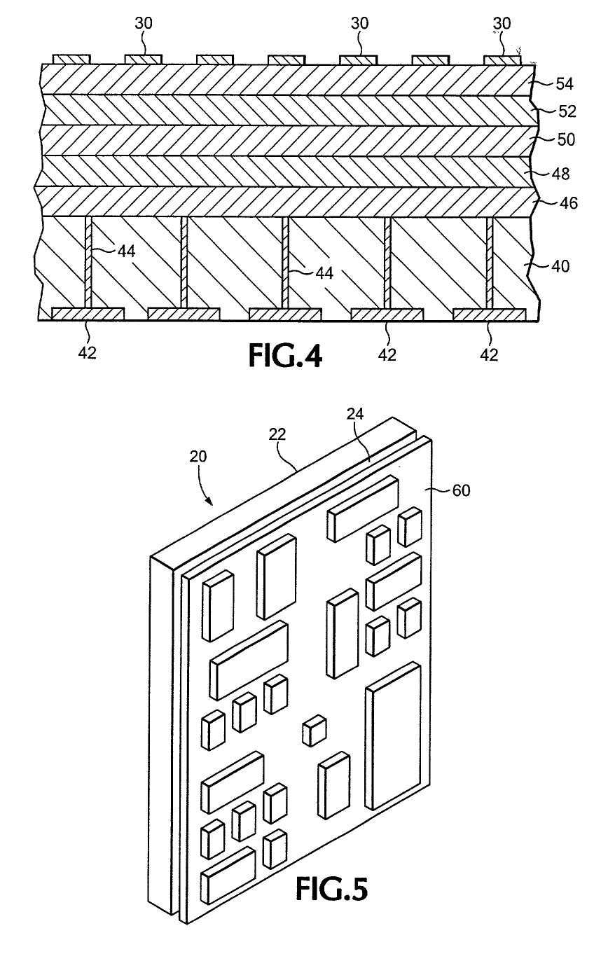

A panel as disclosed herein is shown in partial cross-section in FIG. 4. The display panel comprises a panel 40 having a plurality of conventional display cells 42 disposed on the front side 22 or within the panel. The display cells have pixels therein which are illuminated so as to electrically display an image. The display cells are controlled by a driver circuit coupled thereto via display cell contacts 44. Such display cells are known in the art.

On the back side 24 of the panel is an insulating layer 46 and an electrically conductive circuit layer 54. The circuit layer in this embodiment comprises traces routed from the display cell contacts 44 to the pattern of contacts for the driver circuit 30.

The pattern of contacts 30 of the circuit layer 54 is coupled to display contacts 44 for display cells in the panel. Display contacts 44 are thereby coupled the display cells to an electrically conductive circuit layer 54. The original front panel contacts can be used as the attachment points for the multiple boards. Alternatively, the above described circuit layer can be utilized as the set of driver circuit connects. While this description implies the use of a single insulating layer 54, contacts 44 and circuit pattern 54, this concept can obviously be extended to multiple layers, providing for increased complexity in the front screen interconnection circuit, as needed by system or cost considerations.

In a preferred alternative embodiment, electrically conductive traces are routed through a second electrically conductive circuit layer 50, permitting greater freedom in placement of the driver circuit interconnects 30. In this embodiment, a second ceramic or insulating layer 52 is provided, and the first electrically conductive circuit layer 54 (or bond pad layer) provides the pattern of contacts for the driver circuit attachment.

In another embodiment, a panel constructed as in FIGS. 2-4 further can accept a plurality of components on the back side of the panel and in the central region. For example, a panel 20 can have a circuit board 60 attached to the back side 24 in both the central region 28 and the peripheral region 26 (FIG. 5). Multiple circuit boards, with components already attached, can be attached to the back side of the display panel, either directly to the two-dimensional array of contacts on the panel or to the interconnection circuit described above.

FIG. 6 shows a panel constructed according to the present disclosure and having attached to the back side 24 of the panel 20 three circuit boards 60A, 60B and 60C. Placement of the plurality of components is not limited positionally with respect to the panel. For example, a subset of the plurality of components can be connected in the central region and a second subset connected in the peripheral region. The circuit boards can be connected to span both the peripheral and central regions (FIG. 6).

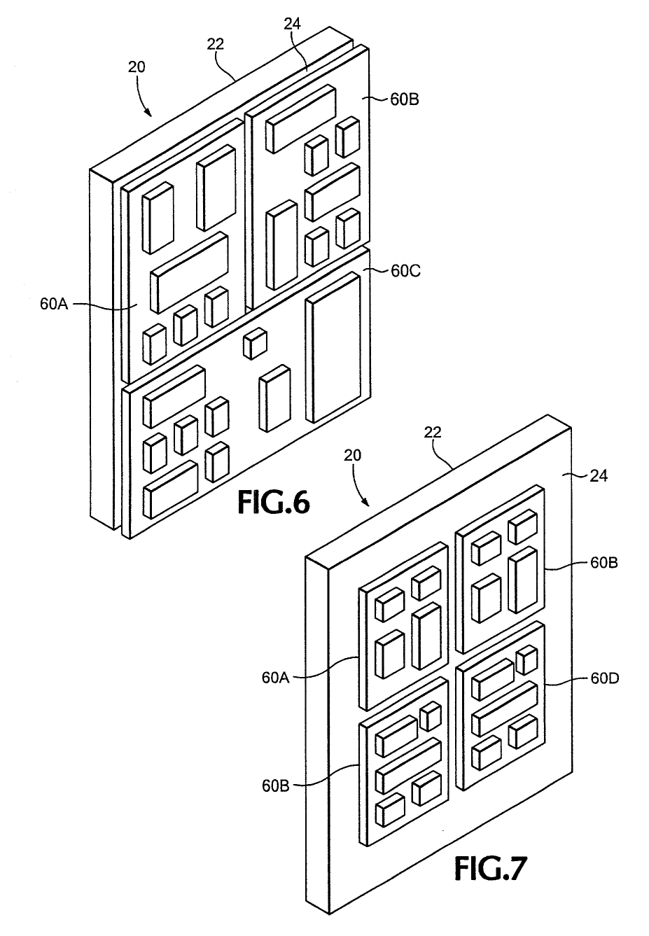

Alternatively, circuit boards smaller than the front panel can be connected to the panel. FIG. 7 shows a panel 20 having attached four circuit boards 60A-60D. The panel is configured so that the circuit boards are mounted in the central region. This configuration permits connection to the display panel of multiple driver circuits or components via contacts fabricated on the back of the display, without the requirement that components be localized to the edge of the panel. Components, such as circuit boards or integrated circuits, can be attached directly to the panel back at virtually any point thereon.

With such an attachment, the edge of the panel can remain free of electrically conductive contacts. The configuration further minimizes the panel dimension requirements. As well, panel planarity restrictions are avoided and testability is increased.

A further advantage of the present panel is that traces coupling the display cell contacts to the bond pads need not be routed to the panel edge. Therefore, trace runs are generally shorter, and the present panel allows greater freedom in X- and Y-axis routing of traces.

Prior art display panels typically have multiple circuits driving multiple emissive displays. The multiple emissive are tiled into one display panel, typically using an interface plate. The present panel can use multiple circuits to drive a single monolithic display. The electronics can be tiled, but the emissive display tiling requirement is removed.

Because the display is not tiled, no interface plate is required. Benefits of the obviation of the interface plate include better optical quality of the display and greater efficiency. The panel configured as disclosed herein is also simpler and cheaper to manufacture.

Mechanical advantages are also realized, in that thermal stresses can be better distributed. The panel and interface plate usually have varying coefficients of thermal expansion (CTE), and expansion and contraction can cause deformation of the panel. The present panel eliminates the need for the plate and spreads remaining thermal stress by localizing it to the circuit boards attached to the display.

This scheme enables a direct attachment approach, such as the chip-on-glass approach employed for LCD manufacturing, while giving the additional advantage of decoupling the interconnect layout requirements of the components from that of the display. These benefits in turn permit concurrent engineering of components and displays with less risk. In addition, this scheme can be exploited to provide additional benefits, such as increased reliability and manufacturing yield through contact redundancy.

In this approach, there may be a need to attach components to the interconnect structure subsequent to fabrication of the display. Temperature limitations associated with the display materials may exist, and such limitations may be inconsistent with the solder temperatures required for the component attachment processes.

In such a case, the components can be pre-attached to smaller circuit boards, which boards can then be attached to the display front panel using an attachment process compatible with the display materials. These smaller boards relax the flatness tolerance requirements placed on an equivalent-sized large board. Smaller boards also provide flexibility in design, purchasing and testing.

While the illustrated embodiment has shown circuit boards attached to the panel, other components can be similarly mounted directly to the interconnection circuit described above. Such components can be active (e.g., integrated circuits) and passive (e.g., resistors, capacitors, connectors) components.

The multiple board approach has the added advantage over direct attachment of integrated circuits of permitting the circuit boards to be pre-tested and, if needed, burned-in prior to attachment to the display panel.

A circuit can be built up directly on the back side of the panel, utilizing the central region in addition to the peripheral region or edge of the panel. The circuit then can be used to connect components. Interconnection circuits are preferably fabricated by using subtractive printed circuit board processes.

The display panel includes an array of display contacts, a layer of conductive circuit lines, and the pattern of contacts.

The circuit board fabrication process introduces a conformal back panel, eliminating the flatness requirement. This approach has an added advantage, in that the circuit board can be fabricated on a large glass panel that can be later excised into separate displays.

Air The process for fabricating a display panel as shown in FIG. 4 entails providing a panel having a plurality of display cells distributed within it.

A display contact layer is formed on one side of the panel. The display contact layer is a two-dimensional array of display contacts coupled to the plurality of display cells. A first insulating layer is deposited onto the display contact layer, with contact vias opened in the insulating layer to provide interconnection between layers. A first electrically conductive circuit layer is formed on the first insulating layer. In this embodiment, the first electrically conductive circuit layer comprises the pattern of interconnects or bond pads to which a component can be attached. The bond pads are structured to have connected thereto one or more components.

Alternatively, the first conductive layer may comprise a plurality of traces routed to the array of display contacts. A second insulating layer is then deposited, and a bond pad layer is formed thereon. Again, vias in the second insulating layer are need to provide interlayer connection. The bond pad layer is coupled to the circuit layer, and is substantially disposed within the central region of the first side of the panel.

The panel as described herein can be incorporated into a variety of devices desiring a flat panel display. The device generally will provide an image generator (e.g., a processor) and a display interface coupling the image generator to the display panel. Such devices include, for example, cellular telephones, palm-top computing devices such as computers and digital assistance devices, and gaming devices.

In prior art panels, each display cell generally does not have its own contact. In a standard display, for example, the number of contacts is equal to the number of columns plus the number of rows. By contrast, the number of contacts in the present panel exceeds that sum, although there are not necessarily as many contacts as there are cells.

A person skilled in the art will be able to make and use the display panel in view of the description present in this document, which is to be taken as a whole. The specific embodiments herein disclosed and illustrated are not to be considered in a limiting sense. Indeed, it should be readily apparent to those skilled in the art in view of the present description that the panel can be modified in numerous ways. The inventor regards the subject matter of the invention to include all combinations and sub-combinations of the various elements, features, functions and/or properties disclosed herein.

1. A device for rendering an image, comprising:
a panel having a viewing side and a non-viewing side, said non-viewing side having:
a peripheral region, and
a central region; and
a pattern of contacts formed in the central region of the non-viewing side.

2. The viewing device of claim 1, wherein the pattern of contacts is configured to receive a component.

3. The viewing device of claim 2, wherein the component is a printed circuit board.

4. The viewing device of claim 2, wherein the component is an integrated circuit.

5. The viewing device of claim 2, wherein the component is a viewing device driver circuit.

6. The display panel of claim 1, further comprising a socket coupled to the pattern of contacts and structured to receive a component in the central zone.

7. The viewing device of claim 1, wherein the pattern of contacts is configured to receive a plurality of components in the central zone.

8. The viewing device of claim 7, further comprising a plurality of components connected to the second side of the panel.

9. The viewing device of claim 1, further comprising:
a display contact layer;
a dielectric layer; and
an electrically conductive circuit layer including the pattern of contacts.

10. The viewing device of claim 9, wherein the display contact layer couples the plurality of display cells and the electrically conductive circuit layer.

11. The viewing device of claim 9, wherein the electrically conductive circuit layer couples the display contact layer and the bond pad layer.

12. The viewing device of claim 9, wherein the bond pad layer includes a plurality of bond pads operative to couple the electrically conductive circuit layer to an attached component.

13. The viewing device of claim 9, wherein the bond pad layer includes a plurality of bond pads operative to couple the electrically conductive circuit layer to an attached plurality of components.

14. A viewing device, comprising:
a panel including:
a plurality of display cells distributed on a first side of the panel, said a plurality of display cells configured to display an image,
a second side of the panel, and
a central zone and a peripheral zone formed on the second side; and
a matrix of interconnects on the second side of the panel, the matrix of interconnects structured to connect a component to the second side of the panel in the central zone.

15. The viewing device of claim 14, wherein the matrix of interconnects is configured to receive a plurality of components.

16. The viewing device of claim 14, wherein the component is a viewing device driver circuit.

17. The display panel of claim 14, further comprising a socket coupled to the matrix of interconnects in the central zone, the socket being adapted to receive a component.

18. An electronic display system, comprising:
an image generator;
a display interface coupled to the image generator; and
a display coupled to the display interface, the display including:
a panel having a first side and a second side, the first side of the panel including a plurality of display cells distributed thereon, the plurality of display cells structured to display an image, and
a matrix of interconnects on the second side of the panel, the matrix of interconnects structured to connect a component to the second side of the panel.

19. The viewing device of claim 18, wherein the panel further includes a periphery and the component is connected to the panel within the periphery.

20. The viewing device of claim 19, wherein a plurality of components are connected to the panel within the periphery.

21. The viewing device of claim 19, wherein the plurality of components include a printed circuit board.

22. The viewing device of claim 19, wherein the plurality of components include an integrated circuit.

23. The display panel of claim 18, further comprising a socket coupled to the matrix of interconnects, the connected component being received in the socket.

24. The electronic device of claim 18, further comprising a video driver interposed between the display interface and the matrix of interconnects.

25. A process for fabricating a display panel of a type that includes a plurality of display cells distributed within the panel, the process comprising:
forming a display contact layer having a two-dimensional array of display contacts coupled to the plurality of display cells;
depositing a first insulating layer; and
forming a bond pad layer coupled to the circuit layer, the bond pad layer substantially disposed within the central region of the first side of the panel.

26. The process of claim 25, wherein the first electrically conductive circuit layer is formed within the central region of the first side of the panel using a subtractive etching process.

27. The process of claim 25, further comprising:
forming, on the first insulating layer, a first electrically conductive circuit layer coupled to the array of display contacts, said first electrically conductive circuit layer comprising traces selectively coupling the display contact layer and the bond pad layer; and
depositing a second insulating layer prior to forming the bond pad layer.

28. The process of claim 27, further comprising:
forming a second electrically conductive circuit layer;
depositing a third dielectric layer; and
wherein the bond pad layer selectively electrically couples the display contact layer to first electrically conductive circuit layer and the second electrically conductive circuit layer.

29. The process of claim 28, further comprising forming a plurality of interlayer connects to electrically couple the first electrically conductive circuit layer to the bond pad layer through the dielectric layer, the second electrically conductive circuit layer, and the third dielectric layer.

30. The process of claim 25, wherein the display cells are emissive display cells.
